(19) United States
(12) Patent Application Publication
(10) Pub. No.: US 2025/0378250 A1
(43) Pub. Date: Dec. 11, 2025

(54) OPTIMIZATION OF LOGIC CIRCUITS BY TRANSDUCTION

(71) Applicant: GDM Holding LLC, Mountain View, CA (US)

(72) Inventors: Xiaoqing Xu, Mountain View, CA (US); Yukio Miyasaka, Berkeley, CA (US)

(21) Appl. No.: 19/223,699

(22) Filed: May 30, 2025

Related U.S. Application Data
(60) Provisional application No. 63/656,213, filed on Jun. 5, 2024.

(51) Int. Cl. G06F 30/337; G06F 119/02

(52) U.S. Cl. CPC G06F 30/337; G06F 2119/02

(57) ABSTRACT

The technology involves improved optimization of logic circuits that yields more efficient logic circuits. Approaches include transduction by insertion, transduction by extension, transduction by insertion and extension, redundancy addition, transduction by generalized node insertion, randomized transduction, error correction via transduction, top-down circuit construction, and dynamic optimization scheduling. Various transduction approaches can be completely decoupled from other operations, such that there is no need to modify code when using existing optimizations. The approaches are implementable using computer processing resources, for instance to generate optimized or corrective logic circuits, which can be fabricated as part of an integrated circuit.

### CROSS REFERENCE TO RELATED APPLICATIONS

The present application claims the benefit of and priority to U.S. Provisional Application No. 63/656,213, filed Jun. 5, 2024, the entire disclosure of which is hereby incorporated herein by reference, including its appendices.

### BACKGROUND

Optimization of a logic circuit (hereinafter also referred to as logic optimization) may include restructuring a logic circuit to generate an improved logic circuit with respect to a given cost function. Some approaches to logic optimizations may include partitioning a logic circuit into multiple smaller partitions of the logic circuit, while preserving the respective functions of the partitions. As used herein, “circuit” may refer to a circuit as a whole or a partition of a circuit. Each partition of the logic circuit can be restructured and optimized independently to improve that logic circuit as a whole. However, the effectiveness of the logic optimization is dependent on and may be constrained by the size of the partitions. Although fine partitioning (smaller partitions) can increase the speed of optimizations (e.g., shorter runtime), fine partitioning can lose global information and limit the effectiveness of optimizations. For instance, nodes/logic gates may not be shared across different partitions. Conversely, coarse partitioning (larger partitions) can optimize a logic circuit more effectively than fine partitioning. However, coarse partitioning can decrease the speed of optimizations (e.g., longer runtime) because coarse partitioning often results in an exponential computational complexity over the input partition size. As such, the effectiveness of previous approaches to logic optimizations is limited.

To improve the effectiveness and scalability of some approaches to logic optimizations, zero-cost transformations of a circuit may be employed. As used herein, “zero-cost transformation” refers to a transformation that alters the structure of a circuit but does not alter a cost of the circuit. A subsequent optimization may then be able to find a different transformation of the circuit that was not applicable before the zero-cost transformation.

Other approaches to improving the effectiveness of logic optimizations employ transformations of a circuit that increase the cost of the circuit in an effort to ultimately improve the circuit. Transduction of a circuit includes a transformation of that circuit and a reduction from the transformed circuit, hence “transduction”. A transformation associated with transduction of a circuit, or a partition thereof, inserts a connection (e.g., a wire) and/or node to the circuit that is redundant to the existing connections and nodes of the circuit, or the partition thereof, without altering the functions at the primary outputs of the circuit, or the partition thereof. A reduction associated with transduction removes one or more connections and/or nodes that are rendered redundant from the transformed circuit.

### SUMMARY

In electrical design automation (EDA), scalability is a concern. Hardware development can benefit from tools that are used to explore efficient design space quickly. Custom processors and programmable accelerators are often desired, for example, in artificial intelligence (AI) and machine learning (ML) implementations. Processors and accelerators may be designed to exploit parallelism existing in AI and ML implementations. The architecture of such processors and accelerators can include an array of identical processing units equipped with arithmetic blocks. Processors can have a number of different arithmetic blocks to optimize. The amount of time allotted for optimizing a processor may be limited. As a result, the amount of time allotted for optimizing each block may be limited.

In contrast, logic circuits such as AI accelerators, for example, can have a few different arithmetic blocks. Thus, even if the amount of time allotted for optimizing a logic circuit is limited, the allotted time is enough to optimize arithmetic blocks of the logic circuit repeatedly (e.g., iteratively). Although previous scalable optimization approaches may be fast, such approaches may not be suitable for logic circuits because they can easily become stuck at a local optimum. In order to more effectively utilize an allotted amount of time for optimization of a logic circuit, approaches disclosed herein utilize multiple different optimizations that enable broader restructuring of the logic circuit even if one or more of the different optimizations may be relatively slow.

Logic synthesis generates a circuit from a function, and is an important step in an EDA flow because it can have a significant impact on the ultimate quality of a circuit design. Logic synthesis impacts as the quality of downstream optimizations is highly dependent on the generated netlist. Logic synthesis is usually divided into two phases: technology-independent synthesis and technology mapping. The former optimizes the design in the form of a simple logic representation such as an AIG (and-inverter graph), XAIG (xor-and-inverter graph), MIG (majority-inverter graph), etc., while the latter converts those representations into a netlist composed of components in the technology library. The advantage of using simple logic representations during synthesis is that they can be handled efficiently without having exceptions for complex gates, and the algorithms can be shared across different technologies. There exists a high correlation between the quality of designs before and after technology mapping.

Due to a recent shift in design trends, logic synthesis has also been directed towards high-effort optimization. One such concept involves area-increasing transformations. In technology-independent synthesis, area means the number of nodes in the representation, since it highly correlates with area after mapping. Conventionally, only transformations that monotonically decrease the area are used in logic synthesis. After generating an initial circuit based on SOP (sum of product), BDD (binary decision diagram), or another decomposition method, local transformations that never increase the area are repeated until convergence. However, since those local transformations are biased by the circuit structure, they may become stuck at a local minimum, resulting in a failed approach. Area-increasing transformations, on the other hand, allow the circuit to grow temporarily so that a larger design space can be explored to find a better local minimum.

The technology as discussed herein include various transduction approaches, including transduction by insertion and/or transduction by extension, generalized node insertion, randomized transduction, error correction via transduction, top-down circuit construction, and dynamic optimization scheduling. The technical benefits of these approaches include improved optimization of logic circuits that yields more efficient logic circuits. Each of these approaches is discussed in detail below.

According to one aspect of the technology, a computer-implemented method for optimization of a logic circuit comprises: creating, by one or more processing resources, a transformed logic circuit by: inserting a logic gate into the logic circuit; extending an input of the inserted logic gate; and coupling an output of a target logic gate of the logic circuit to the extended input of the inserted logic gate; and determining, by the one or more processing resources, an updated logic circuit by removing, from the transformed logic circuit, a redundant structure of the transformed logic circuit, wherein the updated logic circuit is more efficient than the logic circuit.

Removing the redundant structure may include removing a connection of the transformed logic circuit that is rendered redundant by the coupling the output of the target logic gate to the extended input of the inserted logic gate. Removing the redundant structure may include removing another logic gate of the transformed logic circuit that is rendered redundant by the coupling the output of the target logic gate to the extended input of the inserted logic gate.

Determining the updated logic circuit may include determining a connection of the transformed logic circuit that is rendered redundant by the coupling the output of the target logic gate to the extended input of the inserted logic gate, the connection being the redundant structure. Determining the updated logic circuit may include determining another logic gate of the transformed logic circuit that is rendered redundant by the coupling the output of the target logic gate to the extended input of the inserted logic gate, the other logic gate being the redundant structure.

According to one aspect of the technology, a computer-implemented method for optimization of a logic circuit comprises: creating, by one or more processing resources, a first transformed logic circuit by: inserting a logic gate into the logic circuit; coupling an output of a target logic gate of the logic circuit to an input of the inserted logic gate; determining, by the one or more processing resources, whether at least one structure of the first transformed logic circuit is redundant; and responsive to determining that at least one structure of the first transformed logic circuit is redundant, creating, by the one or more processing resources, an updated logic circuit by removing the at least one structure of the first transformed logic circuit.

Creating the first transformed logic circuit may further include determining, at random, the target logic gate of the logic circuit. Here, the method may further comprise, prior to creating the first transformed logic circuit: assigning, by the one or more processing resources to each of a plurality of logic gates of the logic circuit, respective numerical identification; and determining, by the one or more processing resources based on the numerical identification of the plurality of logic gates, a sequence of a plurality of target logic gates of the logic gates. Determining, at random, the target logic gate of the logic circuit may be based on the sequence of a plurality of target logic gates of the logic gates.

The method may further comprise, responsive to determining that no structure of the first transformed logic circuit is redundant: decoupling, by the one or more processing resources, the output of the target logic gate of the logic circuit from the input of the inserted logic gate; and coupling, by the one or more processing resources, an output of a target logic gate of the first transformed logic circuit to the input of the inserted logic gate, the target logic gate of the first transformed logic circuit being different than the target logic gate of the logic circuit. Here, creating the first transformed logic circuit may further include determining, at random, the target logic gate of the logic circuit. Creating the second transformed logic circuit may further include determining, at random, the target logic gate of the logic circuit. The method may further comprise: determining, by the one or more processing resources, whether at least one structure of the second transformed logic circuit is redundant; and responsive to determining that at least one structure of the second transformed logic circuit is redundant, determining, by the one or more processing resources, a different updated logic circuit by removing the at least one structure of the second transformed logic circuit. The method may further comprise, responsive to determining that no structure of the second transformed logic circuit is redundant, determining, by the one or more processing resources, a third transformed logic circuit by: decoupling the output of the target logic gate of the second transformed logic circuit from the input of the inserted logic gate; and coupling an output of a target logic gate of the second transformed logic circuit to the input of the inserted logic gate, the target logic gate of the second transformed logic circuit being different than the target logic gate of the first transformed logic circuit.

The method may further comprise, subsequent to creating the updated logic circuit, determining, by the one or more processing resources based on the updated logic circuit, whether to perform an optimization on the updated logic circuit. Here, the method may further include determining, by the one or more processing resources based on the updated logic circuit, a type of the optimization to perform on the updated logic circuit.

According to one aspect of the technology, a computer-implemented method for error correction of a logic circuit comprises: inserting, by one or more processing resources, one or more circuit elements associated with a first AND operation into the logic circuit, wherein inputs of the first AND operation include a first implied signal of the logic circuit corresponding to a target function of the logic circuit and a second implied signal of the logic circuit corresponding to the target function, wherein the first implied signal is different from the second implied signal; and determining, by the one or more processing resources, whether an output signal of the first AND operation matches the target function.

The method may further comprise responsive to determining that the output signal of the first AND operation does not match the target function of the logic circuit: marking as controlled, by the one or more processing resources, one or more first bit locations of the target function corresponding to one or more bit locations of the output signal of the first AND operation having a value of logic zero; inserting, by the one or more processing resources, one or more circuit elements associated with a first OR operation into the logic circuit; and determining, by the one or more processing resources, whether an output signal of the first OR operation matches the target function. Input signals of the first OR operation may be based on a first implying signal of the logic circuit corresponding to the target function and a second implying signal of the logic circuit corresponding to the target function, wherein the first implying signal is different from the second implying signal. Input signals of the first OR operation may disregard values associated with the one or more first bit locations of the target function marked as controlled.

The method may further comprise, responsive to determining that the output signal of the first OR operation does not match the target function: inserting, by the one or more processing resources, one or more circuit elements associated with a second AND operation into the logic circuit, wherein inputs of the second AND operation include the output signal of the first AND operation and the output signal of the first OR operation; and determining, by the one or more processing resources, whether an output signal of the second AND operation matches the target function of the logic circuit.

The method may further comprise, responsive to determining that the output signal of the second AND operation does not match the target function of the logic circuit: marking as controlled, by the one or more processing resources, one or more second bit locations of the target function corresponding to one or more bit locations of the output signal of the second AND operation having a value of logic one; inserting, by the one or more processing resources, one or more circuit elements associated with a third AND operation into the logic circuit; and determining, by the one or more processing resources, whether an output signal of the third AND operation matches the target function of the logic circuit. Inputs of the third AND operation may be based on the output signal of the first AND operation and a third implied signal of the logic circuit corresponding to the target function, wherein the third implied signal is different from the second implied signal. Inputs of the third AND operation may disregard values associated with the one or more second bit locations of the target function marked as controlled.

The method may further comprise, responsive to determining that the output signal of the third AND operation does not match the target function: marking as controlled, by the one or more processing resources, one or more third bit locations of the target function corresponding to one or more bit locations of the output signal of the third AND operation having a value of logic zero; inserting, by the one or more processing resources, one or more circuit elements associated with a second OR operation into the logic circuit; and determining, by the one or more processing resources, whether an output signal of the second OR operation matches the target function. Inputs of the second OR operation may be based on a third implying signal of the logic circuit corresponding to the target function, wherein the third implying signal is different from the second implying signal. Inputs of the second OR operation may disregard values associated with the one or more third bit locations of the target function marked as controlled.

The method may further comprise, responsive to determining that the output signal of the second OR operation does not match the target function: inserting, by the one or more processing resources, one or more circuit elements associated with a fourth AND operation into the logic circuit, wherein inputs of the fourth AND operation include the output signal of the third AND operation and the output signal of the second OR operation; and determining, by the one or more processing resources, whether an output signal of the fourth AND operation matches the target function of the logic circuit.

### BRIEF DESCRIPTION OF THE DRAWINGS

FIG. 1 illustrates an exemplary integrated circuit design flow in accordance with aspects of the technology.

FIG. 2 illustrates an example system that may be employed with aspects of the technology.

FIGS. 3A-C illustrate an example of transduction in accordance with aspects of the technology.

FIGS. 4A-B illustrate an example of transduction by insertion in accordance with aspects of the technology.

FIGS. 5A-B illustrate an example of transduction by extension in accordance with aspects of the technology.

FIGS. 6A-B illustrate examples of redundancy addition in accordance with aspects of the technology.

FIGS. 7A-B illustrate an example of transduction by generalized node insertion in accordance with aspects of the technology.

FIG. 8 shows an example of randomized transduction in accordance with aspects of the technology.

FIGS. 9A-B illustrate an example of error correction via top-down circuit construction in accordance with aspects of the technology.

FIG. 10 shows an example of a stochastic optimization flow in accordance with aspects of the technology.

FIGS. 11A-G illustrate an example of error correction via top-down circuit construction in accordance with aspects of the technology.

FIGS. 12-14 illustrate example methods in accordance with aspects of the technology.

### DETAILED DESCRIPTION

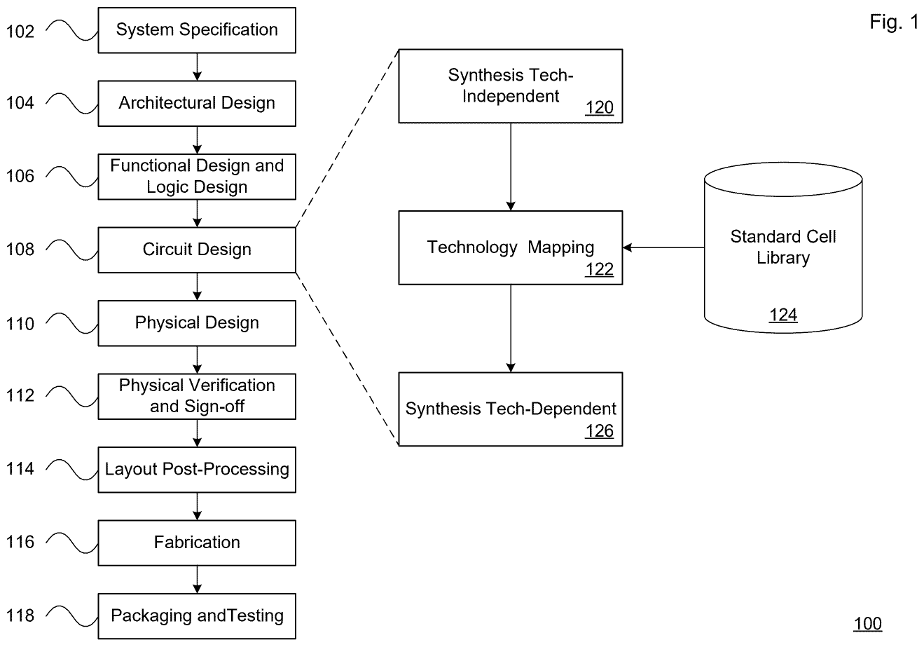

FIG. 1 illustrates an exemplary integrated circuit design flow 100 according to aspects of the technology, including generating a circuit design and/or fabricating an integrated circuit that incorporates any of the transduction-related techniques discussed herein. As shown, the design flow may include preparing a system specification at block 102, such as to identify system-level requirements for the integrated circuit. The system specification is intended to capture the overall goal of the desired integrated circuit. This may include determining the device's cost, performance, general architecture, how off-chip communication will be conducted, etc. The process flow may also include performing architectural design at block 104. At this stage, the design's architecture and its layout are determined by design engineers. This can include integration of memory management, analog and/or mixed-signal components, on-device and external communication, any power constraints, choice of process technology and/or layer stacks, etc.

The process flow continues with performing functional design and logic design at block 106, and performing circuit design at block 108. Functional design may include refinement of the design's specification to achieve the functional behavior of the desired system. Logic design involves adding the design's structure to a behavioral representation of the desired design. Here, considerations include logic minimization, performance enhancement, as well as testability. This stage may consider problems associated with test vector generation, error detection and correction, and the like. By way of example, the functional design and logic design may include generating a behavioral model description (e.g., using HDL) and floor-planning. During circuit design, logic blocks are replaced by corresponding electronic circuits, which may include devices such as resistors, capacitors, and/or transistors. At this stage, circuit simulation may be performed in order to verify timing behavior and other constraints of the system. A SPICE tool or other program may be used for circuit simulation.

Once the circuit design is complete, physical design may be performed at block 110 (e.g., component and wiring placement and routing), followed by physical verification and sign-off at block 112 (e.g., to obtain GDSII information with shapes to form the masks used to create the layers for fabricating the integrated circuit). During physical design, the actual layout of the integrated circuit is performed. Here, all of the components are placed and interconnected using metal interconnections. During this stage, the system may perform optimization of curvilinear interconnects, alternatively or additionally to any other layout operations. A circuit design that is able to pass testing of a circuit simulator in the circuit design stage may be found to be faulty after it has been packaged, e.g., due to geometric design rule issues. Thus, physical design rules are followed to ensure correctness during chip fabrication. Errors may include short or open circuits, open channels, or other issues may result when physical design rules are not followed. During physical verification and sign-off, the system performs any verification steps that are required before chip manufacturing. This can include design rule checking and correction, timing simulation, electromagnetic simulation, etc.

Layout post-processing occurs at block 114, then fabrication at block 116, and the packaging and testing at block 118. At block 114, the layout post-processing may include geometry processing before actual manufacturing, e.g., any dummy fill insertion, correction for optical proximity, mask optimization, etc. Fabrication comprises semiconductor manufacturing, which includes stages such as lithography patterning (masking), baking or annealing, etching, etc. Then the raw die of the chip is inserted into a package and I/O pins are connected to the package at block 118. Testing of the chip also occurs at this stage.

As shown, in the circuit design phase of block 108, the process may involve technology-independent synthesis at block 120. This step involves transferring the circuit definitions, such as register-transfer-level (RTL) descriptions, into generic data structures such as AIG or other inverter graphs, and optimizing the circuit in terms of nodes and levels. As used herein, “node” can refer to a logic gate. For instance, a node of an AIG corresponding to a logic circuit can be a logic gate of that logic circuit including, but not limited to, an AND gate, an OR gate, or a NOT gate. At block 122, technology mapping may be performed based on information from, e.g., a standard cell library or other circuit library 124. This step can involve mapping generic optimized inverter graph descriptions into real, manufacturable standard cells included in the library. From this, technology-dependent synthesis is then performed at block 126. This step further optimizes the circuit defined in the gate-level netlist in terms of power, performance and area, using standard-cell-based definitions from the standard cell library or other circuit library 124.

### Example Integrated Circuit Development System

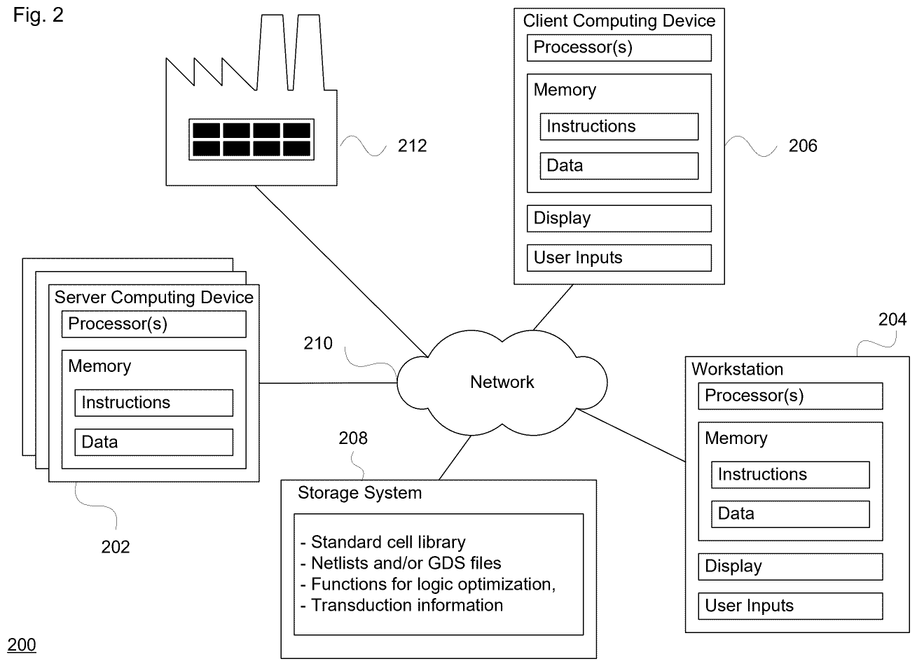

One example of a system for performing circuit design is shown in FIG. 2. In particular, FIG. 2 is a functional diagram, of an example system 200 that includes a plurality of computing devices 202, 204, 206 and a storage system 208 connected via a network 210. System 200 may also include a fabrication facility 212 that is configured to produce integrated circuits designed according to the processes described herein. As shown in FIG. 2, each of computing devices 202, 204 and 206 may include one or more processors, memory, data and instructions.

By way of example, the one or more processors may be any conventional processors, such as commercially available central processing units (CPUs), graphical processing units (GPUs) or tensor processing units (TPUs). Alternatively, the one or more processors may include a dedicated device such as an ASIC or other hardware-based processor. Moreover, reference to one or more processors or processing resources includes situations where a set of processors may be configured to perform one or more operations. Any combination of such a set of processors may perform individual operations or a group of operations. This may include two or more CPUs, GPUs or TPUs (or other hardware-based processors) or any combination thereof. It may also include situations where the processors have multiple processing cores. Therefore, reference to one or more processors or processing resources does not require that all processors (or cores) in the set must each perform all of the operations. Rather, unless expressly stated, any one of the one or more processors (or cores) may perform different operations when a set of operations is indicated, and different processors (or cores) may perform specific operations, either sequentially or in parallel.

As shown in FIG. 2, the memory for each computing device stores information accessible by the one or more processors, including instructions and data that may be executed or otherwise used by the processor(s). The memory may be of any type capable of storing information accessible by the processor, including a computing device or computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. The instructions may include a method for a curvilinear optimization as discussed herein.

The data may be retrieved, stored or modified by the processor(s) in accordance with the instructions. For instance, although the claimed subject matter is not limited by any particular data structure, the data may be stored in computing device registers, in a relational database as a table having a plurality of different fields and records, XML documents or flat files, HDL information, GDSII information, etc. The data may also be formatted in any computing device-readable format.

The computing devices may include all of the components normally used in connection with a computing device such as the processor and memory described above as well as a user interface having one or more user inputs (e.g., one or more of a button, mouse, keyboard, touch screen, gesture input and/or microphone), various electronic displays (e.g., a monitor having a screen or any other electrical device that is operable to display information), and speakers. The computing devices may also include a communication system having one or more wired or wireless connections to facilitate communication with other computing devices of system 200 and/or the fabrication facility 212.

The various computing devices may communicate directly or indirectly via one or more networks, such as network 210. The network 210 and any intervening nodes may include various configurations and protocols including short range communication protocols such as Bluetooth™, Bluetooth LE™, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, computing device 202 may include one or more server computing devices having a plurality of computing devices, e.g., a load balanced server farm or cloud computing architecture, which exchange information with different nodes of a network for the purpose of receiving, processing, and transmitting the data to and from other computing devices. For instance, computing device 202 may include one or more server computing devices that are capable of communicating with computing devices 204, 206 and the fabrication facility 212 via the network 210. In some examples, client computing device 204 may be an engineering workstation used by a developer to perform circuit design and/or other processes for integrated circuit design and fabrication. Client computing device 206 may also be used by a developer, for instance to prepare system requirements for the integrated circuit or manage the manufacturing process with the fabrication facility 212.

Storage system 208 can be of any type of computerized storage capable of storing information accessible by the server computing devices 202, 204 and/or 206, such as a hard-drive, memory card, ROM, RAM, DVD, CD-ROM, flash drive and/or tape drive. In addition, storage system 208 may include a distributed storage system where data is stored on a plurality of different storage devices which may be physically located at the same or different geographic locations. Storage system 208 may be connected to the computing devices via the network 210 as shown in FIG. 2, and/or may be directly connected to or incorporated into any of the computing devices.

Storage system 208 may maintain various types of information. For instance, the storage system 208 may store one or more standard cell libraries or other libraries, netlist and/or GDS files, functions for logic optimization, as well as transduction-related information. This information can be used by the system 200 to autonomously design and/or fabricate logic circuits or complete integrated circuits.

### Transduction

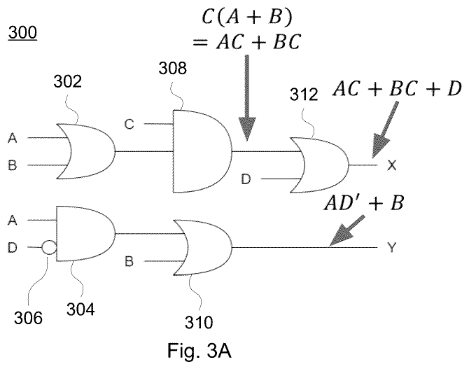

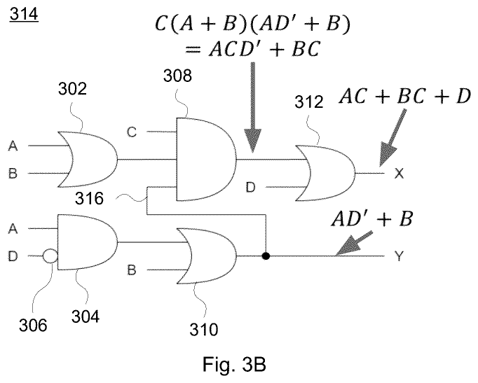

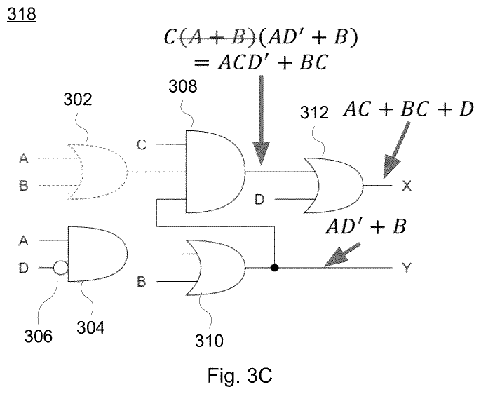

FIGS. 3A-C illustrate an example of transduction in accordance with aspects of the technology. The logic circuit 300 includes an OR gate 302 that receives input signal A and input signal B. The logic circuit 300 also includes an AND gate 308 that receives the output signal from the OR gate 302, A+B, and input signal C. The logic circuit 300 includes an OR gate 312 that receives the output signal from the AND gate 308, C(A+B), which is equivalent to AC+BC, and input signal D. The output signal from the OR gate 312, AC+BC+D, is output signal X of the logic circuit 300.

The logic circuit 300 further includes an AND gate 304 that receives input signal A and the inverse of input signal D, D′, via a NOT gate 306. The logic circuit 300 includes an OR gate 310 that receives the output signal from the AND gate 304, AD′, and input signal B. The output signal from the OR gate 310, AD′ +B, is output signal Y of the logic circuit 300.

In FIG. 3B, the logic circuit 300 illustrated in FIG. 3A is transformed by the addition of another input to the AND gate 308 via a connection 316 (e.g., a wire) from the output of the OR gate 310. Thus, in the transformed logic circuit 314, the additional input signal to the AND gate 308 is AD′+B.

As a result, the output signal of the AND gate 308 is now C (A+B) (AD′+B), which is equivalent to ACD′+BC. This changes an input signal to the OR gate 312 from AC+BC in the logic circuit 300 to ACD′+BC. However, the output signal of the OR gate 312, which is the output signal X of the transformed logic circuit 314, is unchanged by the addition of the connection 316 and remains AC+BC+D.

In the transformed logic circuit 314, the output signal of the AND gate 308, C(A+B)(AD′+B), or ACD′+BC, would be unchanged by removing A+B as an input signal. That is, C(AD′+B) is also equivalent to ACD′+BC. Therefore, the input of A+B, or even the entire AND gate 302, can be removed from the transformed logic circuit 314 (as indicated by the dashed lines of 302, its inputs and its outputs) to generate reduced logic circuit 318 illustrated by FIG. 3C.

The transformation of the logic circuit 300 and the reduction of the transformed logic circuit 314 are transductions, and the reduced logic circuit 318 is the result of transduction of the logic circuit 300.

### Transduction by Insertion

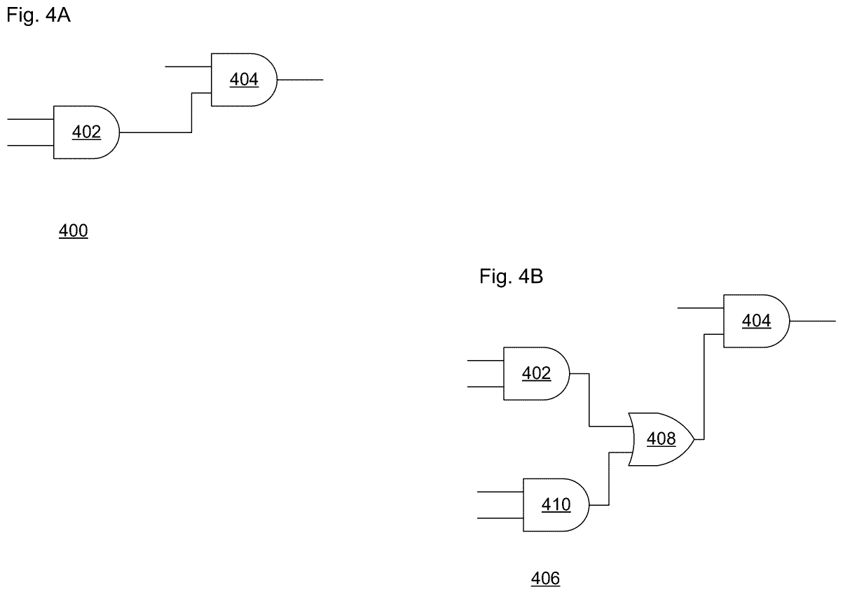

FIGS. 4A-B illustrate an example of transduction by insertion in accordance with aspects of the technology. The transduction example described in association with FIGS. 3A-C included a transformation by adding the connection 316 to the logic circuit 300. The transduction example described in association with FIGS. 4A-B includes transforming the logic circuit 400 by inserting a logic gate.

In particular, FIG. 4A illustrates a logic circuit 400 including a first AND gate 402 and a second AND gate 404. The output of the AND gate 402 is coupled to an input of the AND gate 404. Note that the logic circuit 400 can be a portion of a logic circuit that is not illustrated.

As shown in FIG. 4B, transduction to yield transformed logic circuit 406 can include inserting (adding) a 2-input node (logic gate) on the connection (e.g., a wire) from the output of the AND gate 402 to an input of the AND gate 404. Any type of two-input node can be inserted to the logic circuit 400 that takes the output of the AND gate 402 as an input. Here, the transformed logic circuit 406 includes an OR gate 408 having the output of the AND gate 402 as an input. The output of the OR gate 408 is coupled to an input of the AND gate 404.

Another input of the OR gate 408 is a signal of the transformed logic circuit 406 or the logic circuit that includes the transformed logic circuit 406. Determination of which signal of is input to the OR gate 408 can be based on a topological order of the transformed logic circuit 406 or the logic circuit that includes the transformed logic circuit 406. Alternatively or additionally, determination of which signal of is input to the OR gate 408 can be random or pseudo-random. Alternatively or additionally, determination of which signal of is input to the OR gate 408 can be based on high-level flow of optimizations of the transformed logic circuit 406 or the logic circuit that includes the transformed logic circuit 406.

By way of example, as shown in FIG. 4B, a signal output by an AND gate 410 of the logic circuit that includes the transformed logic circuit 406, as shown via the line out from the AND gate 410 is input to the OR gate 408. Although not illustrated by FIG. 4B, the AND gate 410 can have other fanouts. The AND gate 410 is selected to be coupled (input) to the OR gate in association with the transduction of the logic circuit 400.

### Transduction by Extension

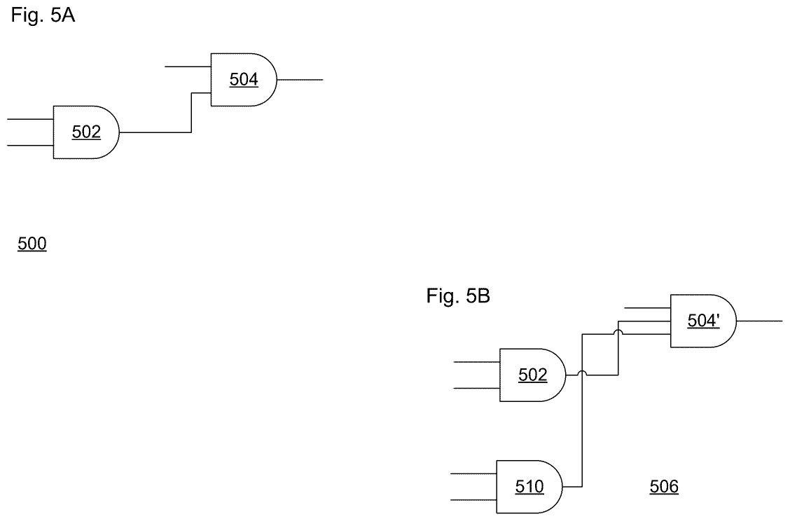

FIGS. 5A-B illustrate an example of transduction by extension in accordance with aspects of the technology. FIG. 5A illustrates a logic circuit 500 including a first AND gate 502 and a second AND gate 504, as with the example in FIG. 4A. The output of the AND gate 502 is coupled to an input of the AND gate 504. The logic circuit 500 can be a portion of a logic circuit that is not illustrated.

Transduction by extension can include adding N connections (e.g., wires) to inputs of an M-input node to extend the M-input node to have N+M inputs. Transduction by extension can be beneficial in that “don't-cares” can be calculated equally for the inputs of the extended node. In contrast, transduction by insertion includes a transformation to insert substructure between existing nodes, which can bias redundancy removal in reduction associated with the transduction. Performing redundancy removal in reverse topological order, as in transduction by insertion, evaluates the inserted substructure first and removes connections within the inserted substructure, if possible. Transduction by extension, however, removes existing nodes and/or connections from the logic circuit, which can result in a more improved structure of the logic circuit then transduction by insertion.

As shown in FIG. 5B, transduction by extension of the logic circuit 500, which yields the transformed logic circuit 506, can include adding a connection (e.g., a wire) from the output of an existing node, an AND gate 510, to the input of another existing node, the AND gate 504′. The AND gate 504′ is thus extended to have one more input for three inputs total.

### Redundancy Addition

There are various ways to add redundant connections or nodes to a circuit. One way is single-wire addition or multi-wire addition, with or without inserting a complemented node. MIAIGs (multi-input-AIGs) may be employed as an intermediate representation. An MIAIG has multi-input AND gates along with inverters. One can convert an MIAIG into an AIG simply by decomposing each N-input MIAIG node into cascaded N-1 AIG nodes. The benefit of using MIAIG is that it can reduce the structural bias in don't-cares. One aspect of the technology is based on compatible don't-cares, which is a subset of all don't-cares where at least one of the controlling fan-ins will remain unchanged for each controlling pattern. In MIAIGs, one can efficiently shuffle those don't-cares by permuting the fan-ins of multi-input nodes.

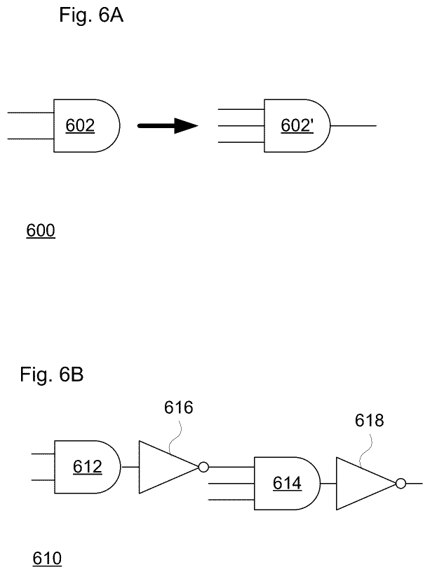

Redundancy addition is performed by increasing the number of inputs of the target node with extra fan-in(s), which is shown in scenario 600 of FIG. 6A. Here, while only one additional fan-in is added, any number of additional fan-ins may be introduced. The approach traverses the circuit except the transitive fanout (TFO) of the target node to find connectable signal(s). If the function of the node (or its negation) satisfies the connectable condition with respect to the target node, a wire is added from the node (respectively, its negation) to the target node.

For single-wire additions, redundancy removal can be performed every time a new wire is added. If nothing else can be removed by redundancy removal (i.e., only the newly added wire is redundant), the changes can be canceled by removing the added wire. Otherwise, the changes are maintained, as some circuit restructuring has occurred. On the other hand, for multi-wire addition, redundancy removal may be performed only once after all connectable signals are added to the input of the target node. In this case, the changes are saved when the number of removed wires is not less than the number of added wires, and otherwise they are discarded. The changes can be discarded when the number of wires has increased.

Additionally, to increase the generality, one can also try redundancy addition by inserting a complemented node as shown in scenario 610 of FIG. 6B. The target node 612 here is an AND gate. The process includes first inserting a node with both input and output complemented at the output of the target node such that all previous fanouts of the target node become the fanouts of the inserted node with proper negations. This is shown by inserted node 614 (here, an AND gate with one or more additional fan-outs than AND gate 612). Then, redundant wires are added to the input of the inserted node. The negations are shown by nodes 616 and 618, at the input and output of the inserted node 614, respectively. This redundancy addition corresponds to the insertion of an OR gate.

### Transduction by Insertion and Extension

As described in association with FIGS. 5A-B, transduction by extension maintains the type of the extended node. In transduction by insertion and extension, a M-input node of any type (e.g., OR gate 410 described in association with FIG. 4B) is inserted to a logic circuit and coupled to the output of a target node of the logic circuit. Then, the inserted node is extended by adding N connections (e.g., wires) to inputs of the inserted node to have N+M inputs. Transduction by insertion and extension can utilize transformations that would not be suitable for the type of the node the logic circuit had originally.

Transduction by Generalized Node Insertion

In contrast to transduction by insertion described in association with FIGS. 4A-B that inserts a node on a given connection between two other nodes of a logic circuit, transduction by generalized insertion utilizes the inserted node across connections of a subset of a logic circuit or the entire logic circuit. The output of the inserted node is iteratively coupled to an input of each node of the subset of the logic circuit or the entire logic circuit. The inserted node can be any type of node and have any number of inputs.

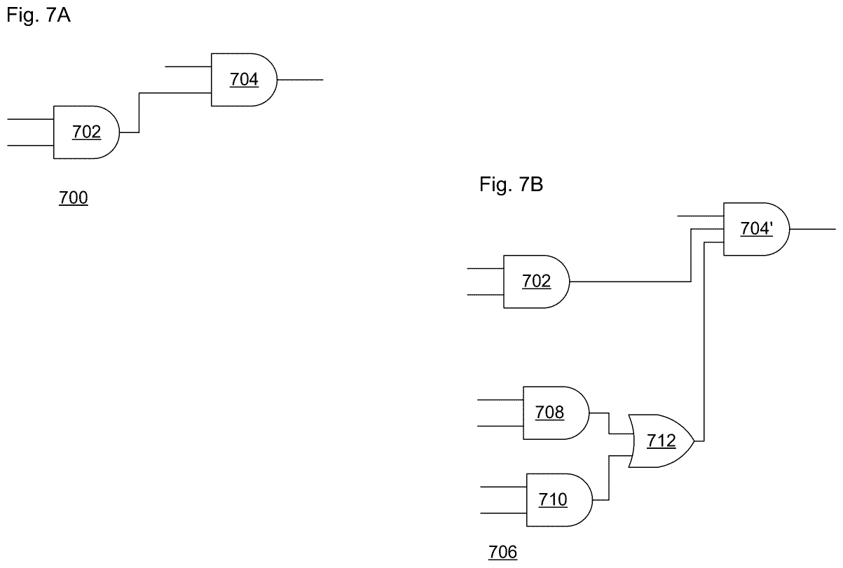

FIGS. 7A-B illustrate an example of this generalized approach. FIG. 7A illustrates a logic circuit 700 including a first AND gate 702 and a second AND gate 704, as with the example in FIG. 4A. The output of the AND gate 702 is coupled to an input of the AND gate 704. The logic circuit 700 can be a portion of a logic circuit that is not illustrated. In the transformed circuit 706 of FIG. 7B, two AND gates, 708 and 710, selected from existing gates of the logic circuit that includes the transformed logic circuit 706, are introduced. An OR gate 712 is newly introduced in the transformed logic circuit 706. Here, the outputs of the AND gates 708 and 710 are the inputs to the OR gate 712. The output of the OR gate 712 is a new input to the AND gate 704′. The AND gate 704′ is thus extended to have one more input for three inputs total.

For each iterative coupling of the inserted node to another node of the logic circuit, reduction associated with transduction (e.g., redundancy removal) is performed. If the reduction for a given coupling of the inserted node results in no other connections (e.g., wires) of the logic circuit being removed, then that coupling of the inserted node is dismissed.

In addition to iteratively coupling the output of the inserted node to an input of each node of the subset of the logic circuit or the entire logic circuit, a negation (e.g., a NOT gate) can be inserted on the output of the inserted node to the other node. For example, reduction can then be performed with the output of the inserted node coupled to an input of a node of the subset of the logic circuit or the entire logic circuit and with the negated output of the inserted node coupled to the input of the node of the subset of the logic circuit or the entire logic circuit.

Example pseudocode associated with transduction by generalized insertion, as described herein, is shown below.

```
void GeneralizedNodeInsertion(signal i, signal j) {
  Create a node x with input i and j;
  for (each node y in the circuit) {
    if (a new wire from x to y does not change the output
    functions of the circuit) {
      Add a new wire from x to y;
        Apply redundancy removal while keeping the new wire;
        if (none of the other wires have been removed)
          Delete the new wire;
    }
  }
  Apply redundancy removal;
  if(circuit quality has degraded compared to the beginning of
  this function)
    Restore the circuit at the beginning of this function;
}
```

### Randomized Transduction

Some approaches to optimization of logic circuits include performing transduction for multiple nodes (e.g., logic gates) or every node in the logic circuit before employing other types of optimization than transduction. Non-limiting examples of other optimizations that can be employed include lookup table (LUT) mapping and unmapping, reshuffling, and other AIG-based optimizations including, but not limited to, rewriting. Such approaches employ transduction in an isolated manner by performing transduction iteratively on multiple, if not all, nodes in a logic circuit before employing before performing any other type of optimization. These approaches iteratively perform transduction in a single round upfront before considering another type of optimization. Results from performing transduction on one node of a logic circuit can affect subsequent performance of transduction, and other types of optimizations, on another node of the logic circuit.

For instance, a transformation associated with transduction on a node of a circuit may cause other transformations associated with subsequent transduction or other optimizations on another node of the logic circuit to be unavailable or unapplicable. Other types of optimizations than transduction may be quicker and/or exploit changes to the logic circuit resulting from transduction on a node. Thus, approaches that perform transduction on multiple nodes before employing other types of optimizations consume more resources (e.g., time) and fail to exploit the results of performing transduction on multiple nodes.

In view of this, an aspect of the present disclosure includes performing transduction on a single node of a logic circuit that is selected at random. This is an approach that can be used in a stochastic flow. As discussed herein, the approach performs redundancy addition and removal as described above with a target node selected in a random order, and it terminates when it finds a different structure that contains a smaller or equal number of nodes.

A random number generator can be used to determine which node is selected. For example, an order of nodes can be shuffled based on generated numbers. After performing transduction on that randomly selected node, one or more other optimizations are then performed on the logic circuit. Using this technique, approaches described herein can be more efficient than previous approaches because one or more other optimizations that may be quicker than transduction are employed before transduction is performed on another node of the logic circuit. This can exploit changes to the logic circuit resulting from performing transduction on a single node. Different than reshuffling, this approach can use various kinds of redundancy addition, with don't cares.

Moreover, the system can force the randomized transduction to perform a zero-cost or cost-decreasing transformation. It can then discard the result when the cost has increased, and run the process again with a different target node randomly chosen. When there are no nodes resulting in such a transformation, the system may simply move on to the next step in the optimization flow. Thus, when performing transduction on a single node results in a cost increase associated with the node, then the resulting changes to the logic circuit can be dismissed and transduction can be performed on a different, randomly selected node of the logic circuit.

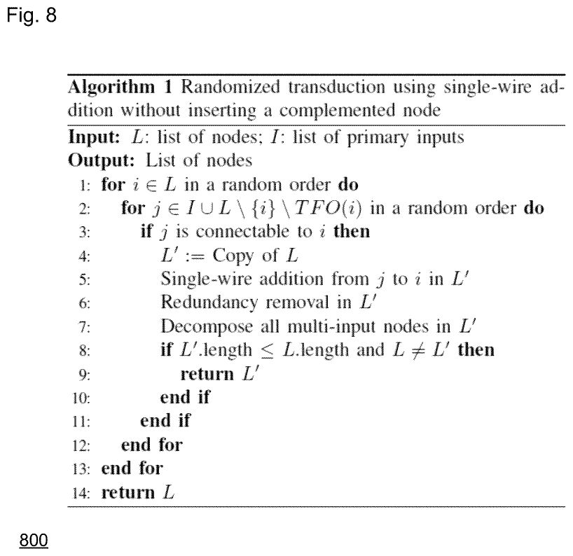

Algorithm 1 of FIG. 8 shows an example of randomized transduction using single-wire addition without inserting a complemented node. In the (unlikely) case that the flow cannot find such a structure, it returns the original one. Optionally, for each node in the inner loop, the process can also add its negation to the input of the target node if that is connectable. Additionally, for each target node, the process can try wire addition both with and without inserting a complemented node, while their order is randomized as well.

### Error Correction via Transduction

Transduction can be used to compensate for an error in a logic circuit. For example, if a particular pattern at a primary input of a logic circuit (also referred to as a primary input pattern) causes an error at one or more primary outputs of the logic circuit, then that pattern can be denoted as don't-care for those primary outputs. As used herein, “pattern” refers to an assignment of input signals. For example, a=1, b=0, and c=1 for input (a, b, c) would be one exemplary pattern. As used herein, “primary input” refers to an input of an entire logic circuit as opposed to an intermediate input within the logic circuit. As used herein, “primary output” refers to an output of an entire logic circuit as opposed to an intermediate output within the logic circuit.

Initially, “don't-care” refers to a primary input pattern, which is determined for a logic gate, where the output of that logic gate does not affect the primary output(s) of the logic circuit. The don't-care designation propagates to the fan-ins of that logic gate. If a logic gate has multiple fanouts, then that logic gate receives a don't-care only for primary input patterns where all those fanouts are don't-care. By designating don't-cares at the primary outputs for primary input patterns causing an error and propagating the don't-cares through the logic circuit, transduction can then change the function(s) on the logic gate(s) that causes the error. Doing so can correct the error because transduction can change output of the logic gate for don't-care patterns. After the error is corrected for that input pattern, then the don't-care designation is removed from the input pattern such that and the corrected output pattern will be maintained.

### Top-Down Circuit Construction

Error correction via transduction may take a long time to correct multiple errors if a logic circuit is complex. To increase the scalability of error correction, certain error correction approaches disclosed herein, referred to as top-down circuit construction, can be independent of transduction.

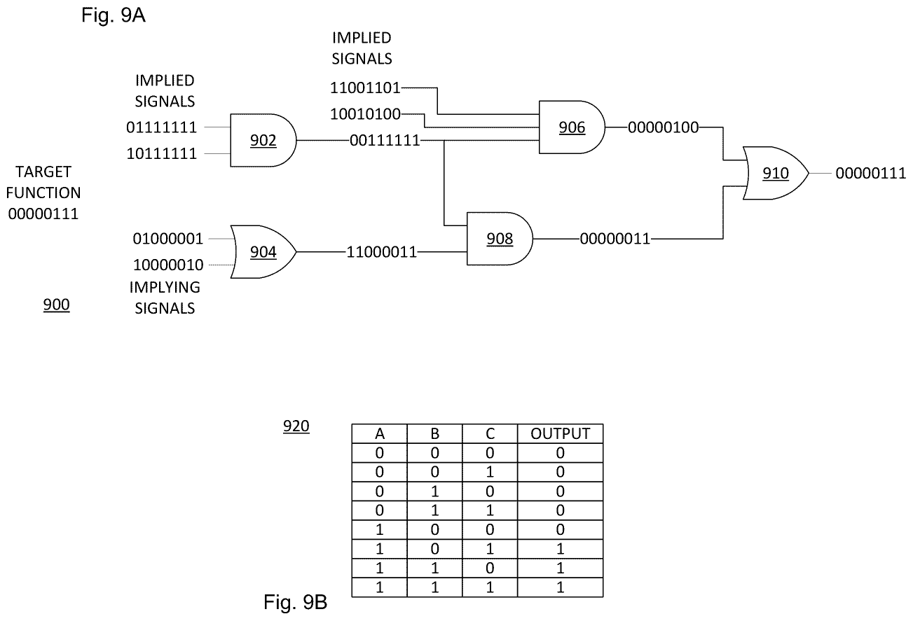

FIGS. 9A-B illustrate an example of error correction via top-down circuit construction in accordance with aspects of the technology. The logic circuit 900, illustrated in FIG. 9A, is an exemplary logic circuit generated using top-down circuit construction as described herein. The logic circuit 900 may be added to another logic circuit (not illustrated) that has an error (e.g., an erroneous primary output). A logic circuit that has an error is also referred to herein as an erroneous logic circuit. The logic circuit 900 corrects (e.g., replaces) the erroneous primary output with a target function. The target function indicates logic functions to be performed by a logic circuit expressed as bit sequences, which correspond to the output column in an associated truth table.

In this example, the erroneous logic circuit has three primary inputs A, B and C. The target function of the erroneous logic circuit is expressed by the bit sequence 00000111, which corresponds to the output column of a truth table 920, illustrated in FIG. 9B, associated with the erroneous logic circuit.

In this example, top-down circuit construction begins with inserting an AND gate 902 the logic circuit 900. Implied signals from the erroneous logic circuit, corresponding to the target function, are input to the AND gate 902. As used herein, “implied signal” refers to a signal that has a function that takes logic value one for bit locations where the target function also takes logic value one.

Here, bit locations of the output signal of the AND gate 902, 00111111, are marked as controlled where the output signal of the AND gate 902 has logic value zero. In this example, implied signals 01111111 and 10111111 are primary input patterns to the AND gate 902. Thus, because the first and second bit locations of the output signal of the AND gate 902, 00111111, have logic value zero, the two leftmost bit locations (the first and second bit locations) of the output signal of the AND gate 902 are marked as controlled.

In this example, because the output signal of the AND gate 902, 00111111, does not match the target function, 00000111, top-down circuit construction includes inserting an OR gate 904 to the logic circuit 900. Implying signals from the erroneous logic circuit, corresponding to the target function, are input to the OR gate 904. As used herein, “implying signal” refers to a signal that that has a function that takes logic value zero at bit locations where the target function also takes logic value zero. In this example, implying signals 01000001 and 10000010, are input patterns to the OR gate 904. However, bit locations of the implying signals 01000001 and 10000010 corresponding to the bit locations of the output signal of the AND gate 902 that are marked as controlled (e.g., the two leftmost bit locations), are disregarded (e.g., “don't care”).

In this example, because the output signal of the OR gate 904, 11000011, does not match the target function, 00000111, top-down circuit construction includes inserting AND gate 908 to the logic circuit 900. The output signals of the AND gate 902, 00111111, and the OR gate 904, 11000011, are input to the AND gate 908. The AND gate 908 may be thought of as summarizing the output signals of the AND gate 902 and the OR gate 904. The output signal of the AND gate 908 is 00000011.

Here, bit locations of the output signal of the AND gate 908, 00000011, are marked as controlled where the output signal of the AND gate 908 has logic value one. In this example, the implied signals 00111111 and 11000011 are input patterns to the AND gate 908. Thus, because the seventh and eighth bit locations of the output signal of the AND gate 908, 00000011, has logic value one, the two rightmost bit locations (the seventh and eighth bit locations) of the output signal of the AND gate 908 are marked as controlled.

In this example, because the output signal of the AND gate 908, 00000011, does not match the target function, 00000111, top-down circuit construction includes inserting AND gate 906 to the logic circuit 900. Implied signals from the erroneous logic circuit, other than those input to the AND gate 902, are input to the AND gate 906 along with the output signal of the AND gate 902. In this example, implied signals 11001101 and 10010100, and the output signal of the AND gate 902, 00111111, are input patterns to the AND gate 906. However, bit locations of the implied signals 11001101 and 10010100 corresponding to the bit locations of the output signal of the AND gate 908 that are marked as controlled (e.g., the two rightmost bit locations), are disregarded (e.g., “don't care”). The output of AND gate 906 in this example is 00000100.

In this example, because the output signal of the AND gate 906, 00000100, does not match the target function, 00000111, top-down circuit construction includes inserting OR gate 910 to the logic circuit. The output signals of the AND gate 906 and the AND gate 908 are input to the OR gate 910. In this example, the output signal of the OR gate 910, 00000111, matches the target function, 00000111. Thus, no further error correction is needed (e.g., no other additional AND gates or OR gates are needed). The logic circuit 900, including the logic gates 902-910, may be inserted to the erroneous logic circuit to provide error correction and the target function.

If the output signal of the OR gate 910 did not match the target function, then further top-down circuit construction may be performed (e.g., more AND gates and/or OR gates can be inserted as described above), using other implied and/or implying signals from the erroneous logic circuit, until the target function is achieved. If there are no more other implied or implying signals from the erroneous logic circuit to try, then the error correction can end.

Although the description above includes insertion of an AND gate to perform an AND operation, and insertion of an OR gate to perform an OR operation, aspects of the technology are not so limited. By way example, any combination of circuit elements may be inserted to perform an AND operation or an OR operation.

Example pseudocode associated with error correction via top-down circuit construction, as described herein, is shown below.

```
// + and − operators are set union and set subtraction
  void Construct(function f, list<signal> L) {
    // f is the desired function and L is the list of
    all available signals
    S = all signals implied by f;
    F = AND(S);
    if (F == f || ~F == f)
      return;
    T = (all signals implying f taking ~F as don't care) −
    (negation of signals in S);
    G = OR(T);
    G = AND({F, G});
    if (G == f || ~G == f)
      return;
    while (true) {
      U = (all signals implied by f taking G as don't
      care) − S − (negation of signals in T);
      S = S + U;
      F = AND({F} + U);
      F = OR({G, F});
      if (F == f || ~F == f)
        return;
      V = (all signals implying f taking ~F as don't
      care) − T − (negation of signals in S);
      T = T + V;
      G = OR({G} + V);
      G = AND({F, G});
      if (G == f || ~G == f)
        return;
      if (U.empty( ) && V.empty( ))
        return;
    }
  }
```

### Dynamic Optimization Scheduling

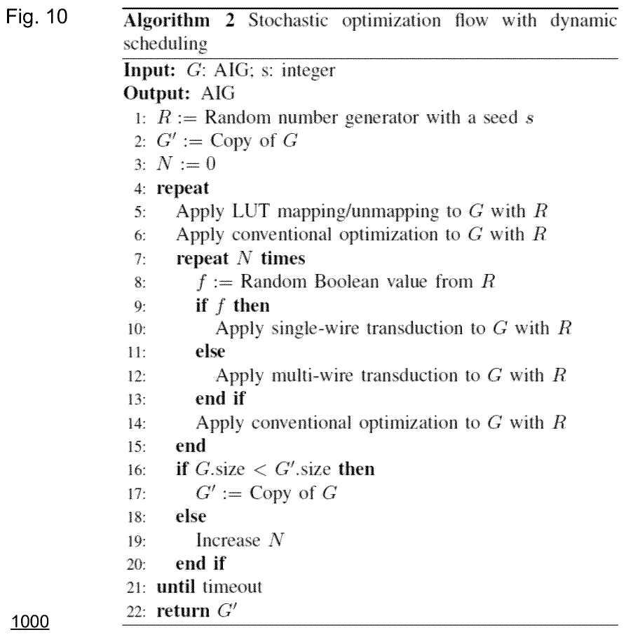

Randomized transduction, as described herein, can be integrated with other optimizations, such as other transformations that add nodes to a logic circuit. However, the order in which optimizations are employed can negatively or positively affect the outcome of the process. The order in which optimizations are employed can be referred to as a schedule. To reduce the likelihood of employing optimizations according to a schedule that negatively or detrimentally affects the outcome of the optimizations, a dynamic scheduling approach can be used. In a dynamic scheduling approach, which optimization (e.g., transformation) to employ in a current iteration can be based on results from one or more previous iterations. An exemplary stochastic optimization flow with dynamic scheduling is shown as Algorithm 2 in FIG. 10.

For instance, a set of optimizations can be available to employ via a dynamic scheduling approach. Non-limiting examples of optimizations that can be employed include transduction, randomized transduction, lookup table (LUT) mapping and unmapping, and reshuffling. A rank can be assigned to each optimization of the set. The ranking indicates the order in which the optimizations are employed. If multiple optimizations are assigned the same rank, then one of the optimizations having the same rank is selected at random.

In one scenario, in the first few iterations, only LUT mapping/unmapping is performed, followed by other AIG-based optimizations (e.g., rewriting), as long as the area decreases (because N remains 0). When the area stops decreasing, the process can start applying randomized transduction N times in the inner loop, where single-wire addition or multiwire addition is selected randomly. The parameter N increases when no improvement was made in each iteration.

In the illustrated algorithm, the flow uses a random number generator (R) to enable broader exploration. Transduction can be randomized by shuffling the order of nodes in a list based on generated numbers. For optimization, a set of AIG-based optimizations are performed based on a generated Boolean value. LUT mapping/unmapping can be randomized by toggling the use of a structural choice algorithm and/or the fast extract algorithm, while the target LUT size can be decided based on the value of a counter.

Multiple iterations of an optimization having a given rank can be employed before switching to the next optimization according to the ranking. However, in the dynamic scheduling approach, the quantity of iterations (i.e., how many iterations) for a given rank is updated dynamically. For example, the rank may be incremented (e.g., increased) only when the current iteration of an optimization yields less than a threshold improvement or no improvement relative to the previous iteration. When the rank is incremented, the optimization having the next rank is employed.

Example pseudocode associated with dynamic optimization scheduling, as described herein, is shown below.

```
circuit StochasticOptimizationFlow(circuit spec) {
    x = copy(spec);
    best = copy(spec);
    until (resource or time limit has reached) {
      bool fImproved = false;
      for (int i from 0 to N) {
        repeat (number of iterations for rank i) {
          Apply transformation of rank i randomly picked to x;
          Apply fast script to x;
          if (cost(x) < cost(best)) {
            best = x;
            fImproved = true;
          }
        }
      }
      if (!fImproved)
        Increase the number of iterations for rank i > 0;
    }
    return best;
  }
```

Thus, according to one aspect of the technology dynamic optimization is able to apply cost-increasing transformations in a particular order. During testing, one observation was that after LUT mapping/unmapping drastically changed the circuit structure, the nearby design space can be exploited with less drastic transformations.

During testing, randomized transduction was integrated into a state-of-the art high-effort AIG-based synthesis command &deepsyn in ABC. The problem faced was that there were different kinds of area-increasing transformations which needed to be scheduled. One observation was that randomized transduction restructures the circuit more locally than LUT mapping/unmapping. It is known to be efficient in optimization to start from global search (LUT mapping/unmapping) and then gradually shift to local search (transduction), but it may be unsuitable to phase out the global search due to the strong nonlinearity of the solution space.

### Implementation Aspects

Transduction in accordance with the above discussion can be implemented using a BDD (binary decision diagram) package as a back-end engine. A BDD is a binary tree with a particular order of variables. Each node is unique, so redundant nodes (equivalent cofactors) are removed). It may be more suitable than a truth table, due to smaller memory usage through node sharing, and higher performance with (cache) memorization. BDDs can be constructed for functions and don't-cares in the circuit of interest. Because the size of a BDD can be highly affected by the variable order, the process can perform variable reordering at the beginning of the flow. The variables can be reordered after constructing BDDs for functions in the circuit, and the resulting variable order can then be saved and used throughout the flow. Although BDDs can be reconstructed every time transduction is called, the BDD package can be reused across different iterations.

### Partitioning AIG and Transduction

A logic circuit, e.g., of an AI accelerator, may be large in scale and have a large-scale AIG. An AIG (e.g., an AIG associated with a large-scale logic circuit) can be partitioned into multiple smaller AIGs, each associated with a portion of the logic circuit. Transduction, as described herein, can be performed on one or more portions of the logic circuit according to the partitions of the AIG rather than on the logic circuit as a whole according to the unpartitioned AIG. By performing transduction according to partitions of a large-scale AIG, the scalability of transduction described herein can be improved relative to transduction according to the large-scale AIG.

Performing transduction according to partitions of an AIG can also increase the speed and/or efficacy of transduction described herein, which in turn improves the overall operation of the system. For instance, transduction can be performed according to multiple partitions of the AIG, in parallel. Thus, multiple portions of a logic circuit can be optimized in parallel (e.g., concurrently). After performing transduction according to multiple, if not all, partitions of an AIG, then the optimized partitions of the AIG can be integrated to generate an optimized AIG and an associated, optimized logic circuit.

### Randomized Transduction and Scalability

As described herein, an aspect of the present disclosure includes performing transduction on a single node of a logic circuit of interest, where that single node is selected at random. Redundancy addition and removal are performed with a target node selected in a random order, until a different structure having a smaller or equal number of nodes as the original logic circuit of interest is achieved. This approach can improve scalability of performing transduction according to a large-scale AIG because transduction may be performed with a subset of nodes of the large-scale AIG instead of all the nodes. However, this approach does not merely forego performing transduction with all the nodes of an AIG. Rather, target nodes of the AIG are selected in a random order, until a different structure having a smaller or equal number of nodes is achieved.

### Example of Top-Down Circuit Construction

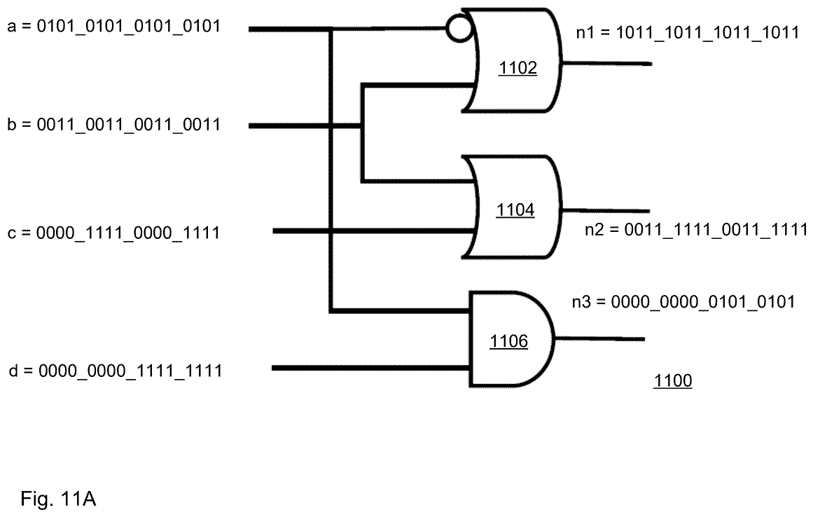

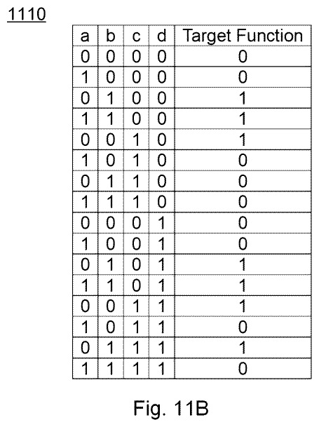

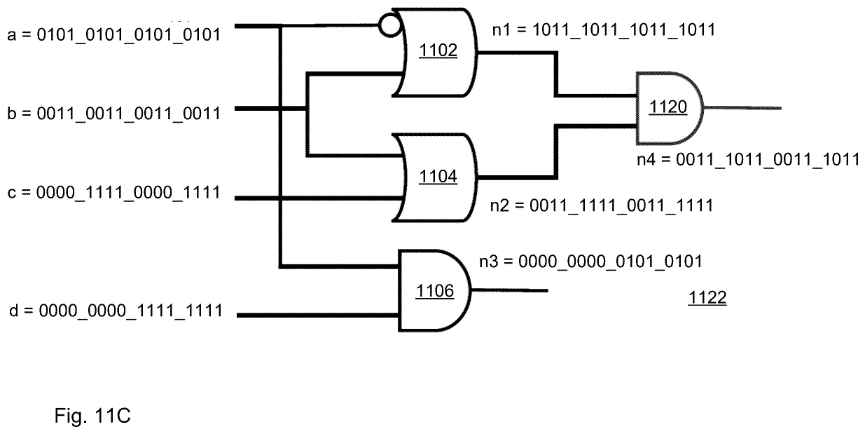

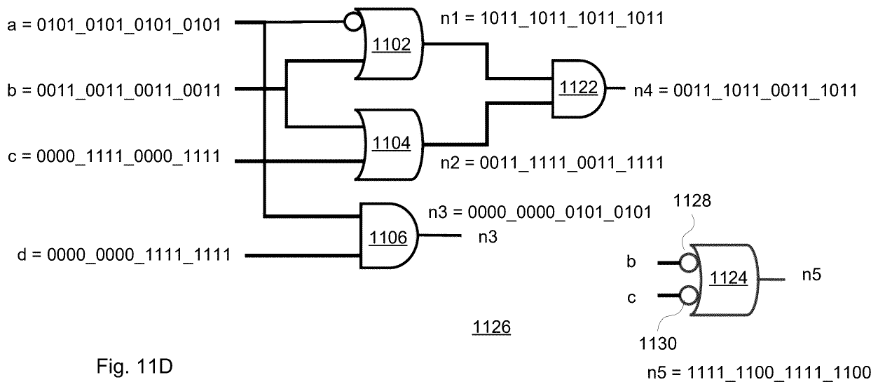

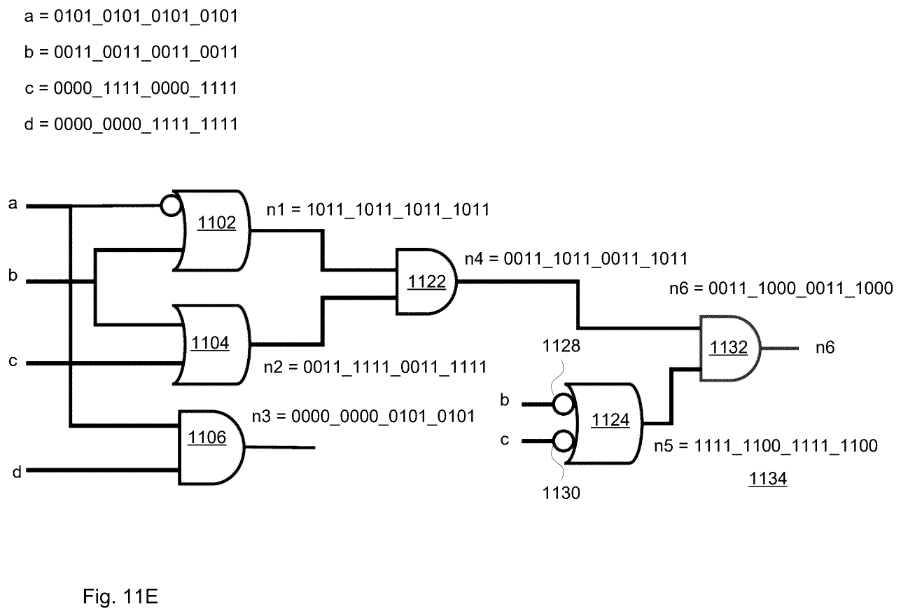

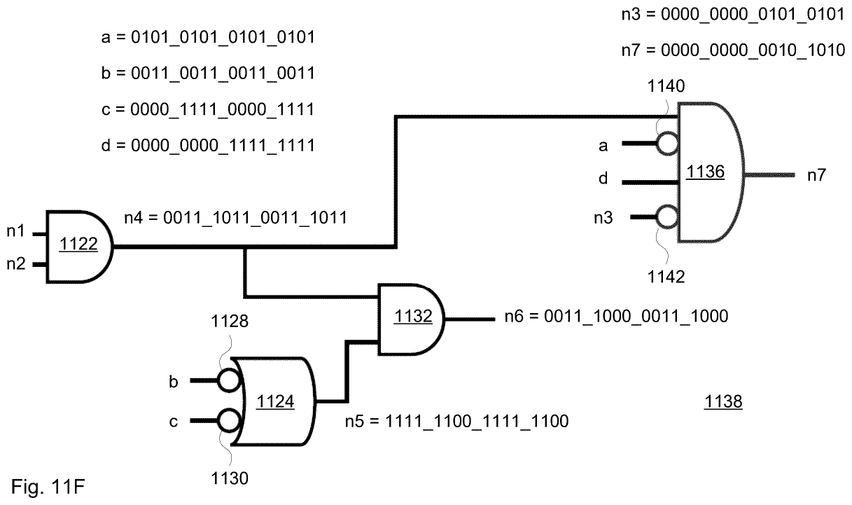

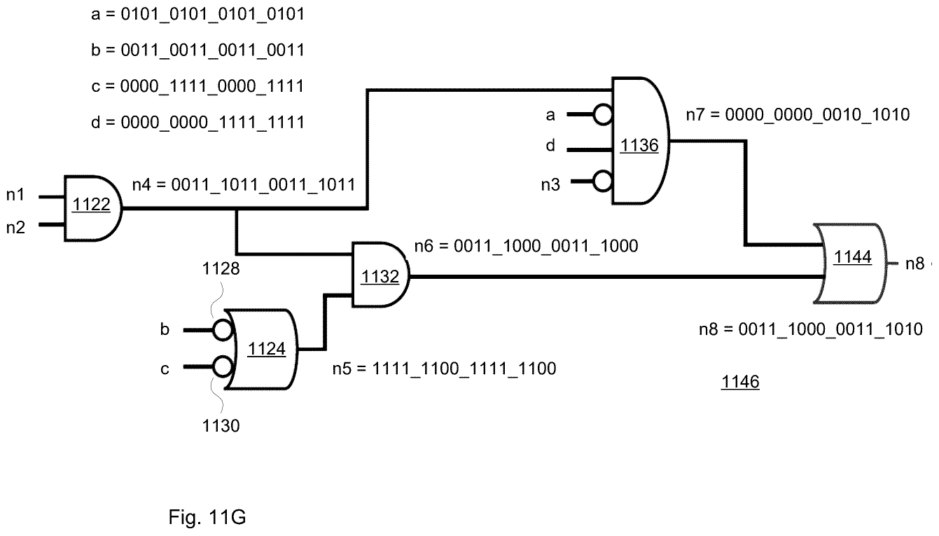

FIGS. 11A-G illustrate an example of error correction via top-down circuit construction in accordance with aspects of the technology. FIG. 11A illustrates a logic circuit 1100 having an error, which is also referred to herein as the erroneous logic circuit 1100. The erroneous logic circuit 1100 includes OR gate 1102, OR gate 1104, and AND gate 1106. The erroneous logic circuit 1100 receives the following primary input patterns (e.g., input signals): a (0101_0101_0101_0101), b (0011_0011_0011_0011), c (0000_1111_0000_1111), and d (0000_0000_1111_1111). In this example, the target function of the erroneous logic circuit 1100 is expressed by the bit sequence 0011_1000_0011_1010. The erroneous logic circuit 1100 does not output this target function. FIG. 11B illustrates a truth table 1110 corresponding to this target function.

As illustrated in FIG. 11C, in this example, top-down circuit construction begins with inserting an AND gate 1120 to the erroneous logic circuit 1100 to generate logic circuit 1122. The AND gate 1120 receives signals n1 (1011_1011_1011_1011) and n2 (0011_1111_0011_1111), which are output signals of the OR gates 1102 and 1104, respectively, as inputs. Signals n1 and n2 are implied signals because they take logic value one for bit locations where the target function also takes logic value one. The output signal of the AND gate 1120, signal n4, is 0011_1011_0011_1011. Here, bit locations of signal n4 where signal n4 and corresponding bit locations of signals n1 and n2 have logic value zero, are marked as controlled (represented by *). Thus, the target function as marked is **11_1*00_**11_1*10. This means that values the bit locations that have been marked as controlled, match the target function. As such, subsequent top- down circuit construction is directed to achieving the values of the target function that have not being marked as controlled.

As illustrated in FIG. 11D, in this example, because signal n4, 0011_1011_0011_1011, does not match the target function, 0011_1000_0011_1010, top-down circuit construction continues with inserting an OR gate 1124 to the logic circuit 1122 to generate logic circuit 1126. Input signals to the OR gate 1124 are based on signals b (0011_0011_0011_0011) and c (0000_1111_0000_1111). Signals b and c are implying signals because they take logic value zero at bit locations where the target function also takes logic value zero. Here, bit locations of signals b and c corresponding to the bit locations of signal n4 that are marked as controlled, are disregarded (e.g., “don't care”). This can be achieved by inserting NOT gates 1128 and 1130 at the inputs of the OR gate 1124 that receive signals b and c. Thus, the input signals to the OR gate 1124 are NOT (b) and NOT (c). The output signal of the OR gate 1124, signal n5, is 1111_1100_1111_1100.

As illustrated in FIG. 11E, in this example, because signal n5, 1111_1100_1111_1100, does not match the target function, 0011_1000_0011_1010, top-down circuit construction continues with inserting AND gate 1132 to the logic circuit 1126 to generate logic circuit 1134. The AND gate 1132 receives signal n4, the output signal of the AND gate 1122, and signal n5, the output signal of the OR gate 1124, as inputs. The AND gate 1132 may be thought of as summarizing the output signals of the AND gate 1122 and the OR gate 1124. The output signal of the AND gate 1132, signal n6, is 0011_1000_0011_1000. Here, the bit locations of signal n6 where signal n6 and corresponding bit locations of signals n4 and n5 have logic value one, are marked as controlled. Thus, the target function as marked is now ***_**00_****_**10. This means that values the bit locations that have been marked as controlled, match the target function. As such, subsequent top-down circuit construction is directed to achieving the values of the target function that have not being marked as controlled.

As illustrated in FIG. 11F, in this example, because signal n6, 0011_1000_0011_1000, does not match the target function, 0011_1000_0011_1010, top-down circuit construction continues with inserting AND gate 1136 to the logic circuit 1134 to generate the logic circuit 1138. For clarity, FIG. 11F does not illustrate the circuit elements of the erroneous logic circuit 1100 shown in FIG. 1A. However, the logic circuit 1138 includes these circuit elements.

Input signals of the AND gate 1136 are based on signals n4, n3, a and d. Signals n3, a and d are implied signals because they take logic value one for bit locations where the target function also takes logic value one. Here, bit locations of signals a and c corresponding to the bit locations of signal n6 that are marked as controlled, are disregarded (e.g., “don't care”). This can be achieved by inserting NOT gates 1140 and 1142 at the inputs of the AND gate 1136 that receive signals a and n3. Here, the target function, as marked, is ****_**00_****_**10, takes logic value one only at the second rightmost bit location. Because signal d, 0000_0000_1111_1111, also takes logic value one at the second rightmost bit location, signal d may be input to the AND gate 1136 directly, without negation. On the other hand, signal a, 0101_0101_0101_0101, does not take logic value one at the second rightmost bit location. However, the negation of signal a, 1010_1010_1010_1010, takes logic value one at the second rightmost bit location. Thus, signal a is used with the NOT gate 1140. The same applies to signal n3, 0000_0000_0101_0101.

Thus, the input signals to the AND gate 1136 include NOT (a) and NOT (n3). The output signal of the AND gate, signal n7, is 0000_0000_0010_1010.

As illustrated in FIG. 11G, in this example, because signal n7, 0000_0000_0010_1010, does not match the target function, 0011_1000_0011_1010, top-down circuit construction continues with inserting OR gate 1144 to the logic circuit 1138 to generate the logic circuit 1146. The other OR gate receives signal n6, the output signal of the AND gate 1132, and signal n7, the output signal of the AND gate 1136, as inputs. The OR gate 1144 may be thought of as summarizing the output signals of the AND gates 1132 and 1136. Here, the output signal of the OR gate 1148, signal n8 matches the target function, 0011_1000_0011_1010.

In this example, because signal n8 matches the target function, top-down circuit construction may be completed. Thus, the logic circuit 1146 can be used to correct the erroneous logic circuit 1100. By way of example, the logic circuit 1146, including circuit elements (e.g., logic gates and connections) inserted as described in association with FIGS. 11C-G, may replace the erroneous logic circuit 1100 to correct the error and achieve the target function. In other words, circuit elements described in association with FIGS. 11C-G may be inserted to the erroneous logic circuit 1100.

Although the description above includes insertion of an AND gate to perform an AND operation, insertion of an OR gate to perform an OR operation, and insertion of a NOT gate to perform a NOT operation, aspects of the technology are not so limited. By way of example, any combination of circuit elements may be inserted to perform an AND operation, an OR operation, or a NOT function.

### Example Methods

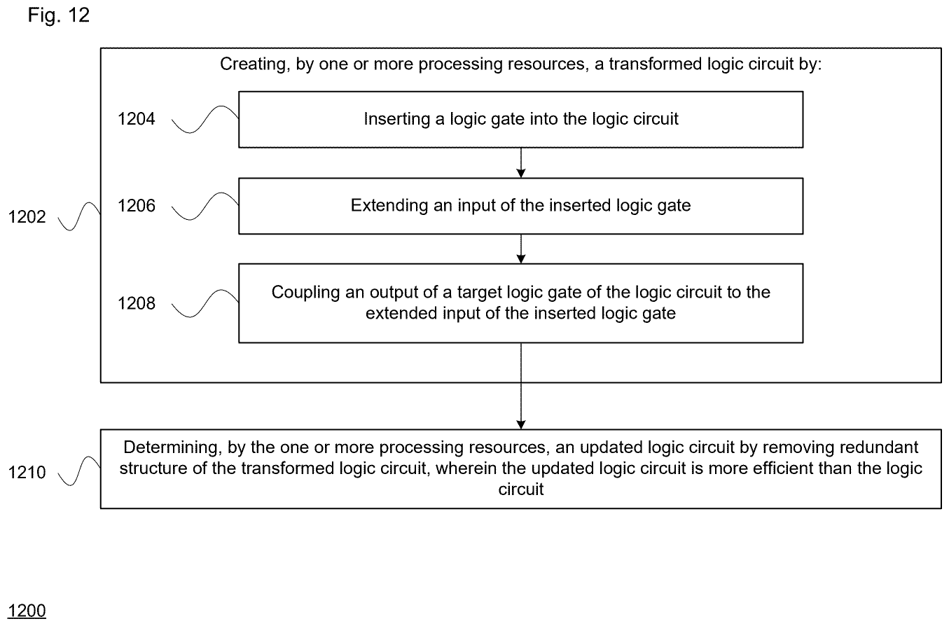

FIG. 12 illustrates an example method 1200 in accordance with the above discussion. At block 1202, the method 1200 includes creating, by one or more processing resources, a transformed logic circuit by: inserting a logic gate into the logic circuit at block 1204; extending an input of the inserted logic gate at block 1206; and coupling an output of a target logic gate of the logic circuit to the extended input of the inserted logic gate at block 1208. At block 1210, the method 1200 includes determining, by the one or more processing resources, an updated logic circuit by removing redundant structure of the transformed logic circuit, wherein the updated logic circuit is more efficient than the logic circuit.

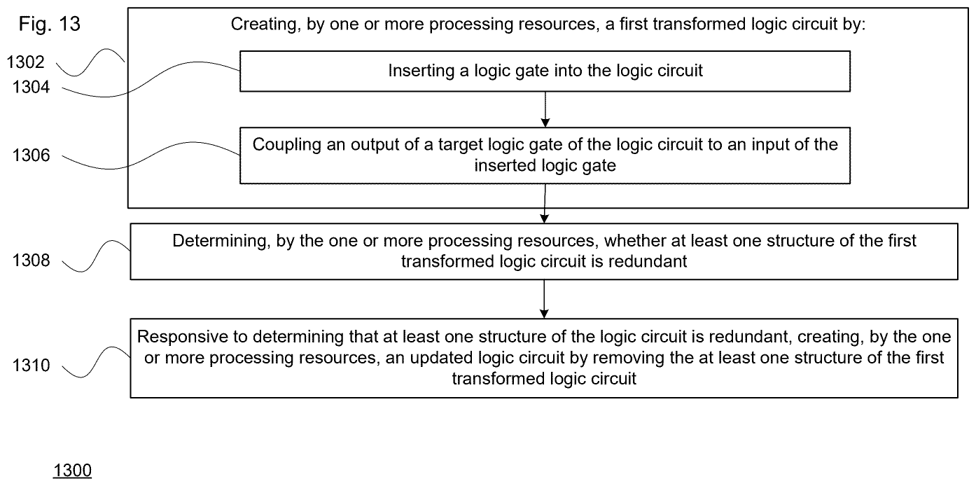

FIG. 13 illustrates an example method 1300 in accordance with the above discussion. At block 1302, the method 1300 includes creating, by one or more processing resources, a first transformed logic circuit by: inserting a logic gate into the logic circuit at block 1304; and coupling an output of a target logic gate of the logic circuit to an input of the inserted logic gate at block 1306. At block 1308, the method 1300 includes determining, by the one or more processing resources, whether at least one structure of the first transformed logic circuit is redundant. At block 1310, the method 1300 includes, responsive to determining that at least one structure of the first transformed logic circuit is redundant, creating, by the one or more processing resources, an updated logic circuit by removing the at least one structure of the first transformed logic circuit.

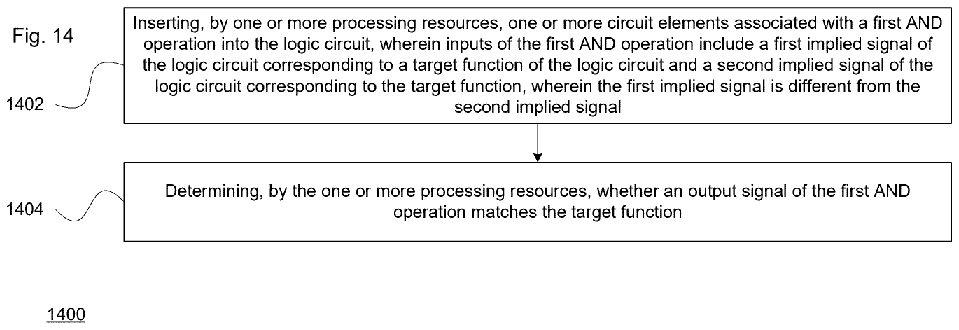

FIG. 14 illustrates an example method 1400 in accordance with the above discussion. At block 1402, the method 1400 includes inserting, by one or more processing resources, one or more circuit elements associated with a first AND operation into the logic circuit, wherein inputs of the first AND operation include a first implied signal of the logic circuit corresponding to a target function of the logic circuit and a second implied signal of the logic circuit corresponding to the target function, wherein the first implied signal is different from the second implied signal. At block 1404, the method 1400 includes determining, by the one or more processing resources, whether an output signal of the first AND operation matches the target function.

The technical benefits of the approaches discussed herein include improved optimization of logic circuits that yields more efficient logic circuits. Another advantage of the technology is that the transduction approaches can be completely decoupled from other operations, such that there is no need to modify code when using existing optimizations. Testing has shown that the approaches discussed herein are able to produce smaller AIGs than conventional techniques. For instance, utilizing randomized transduction may be highly effective and more efficient when searching for a local minimum to a given logic synthesis problem.

The system described above with regard to FIG. 2 can be employed to implement the above- described approaches. Once suitable logic and circuit designs have been obtained, the system can be employed for circuit fabrication.

Although the technology herein has been described with reference to particular embodiments and configurations, it is to be understood that these embodiments and configurations are merely illustrative of the principles and applications of the present technology. It is therefore to be understood that numerous modifications may be made to the illustrative embodiments and configurations, and that other arrangements may be devised without departing from the spirit and scope of the present technology as defined by the appended claims.

1. A computer-implemented method for optimization of a logic circuit, comprising:
creating, by one or more processing resources, a transformed logic circuit by:
inserting a logic gate into the logic circuit;
extending an input of the inserted logic gate; and
coupling an output of a target logic gate of the logic circuit to the extended input of the inserted logic gate; and
determining, by the one or more processing resources, an updated logic circuit by removing, from the transformed logic circuit, a redundant structure of the transformed logic circuit, wherein the updated logic circuit is more efficient than the logic circuit.

2. The method of claim 1, wherein removing the redundant structure includes removing a connection of the transformed logic circuit that is rendered redundant by the coupling the output of the target logic gate to the extended input of the inserted logic gate.

3. The method of claim 1, wherein removing the redundant structure includes removing another logic gate of the transformed logic circuit that is rendered redundant by the coupling the output of the target logic gate to the extended input of the inserted logic gate.

4. The method of claim 1, wherein determining the updated logic circuit includes determining a connection of the transformed logic circuit that is rendered redundant by the coupling the output of the target logic gate to the extended input of the inserted logic gate, the connection being the redundant structure.

5. The method of claim 1, wherein determining the updated logic circuit includes determining another logic gate of the transformed logic circuit that is rendered redundant by the coupling the output of the target logic gate to the extended input of the inserted logic gate, the other logic gate being the redundant structure.

6. A computer-implemented method for optimization of a logic circuit, comprising:
creating, by one or more processing resources, a first transformed logic circuit by:
inserting a logic gate into the logic circuit; and
coupling an output of a target logic gate of the logic circuit to an input of the inserted logic gate;
determining, by the one or more processing resources, whether at least one structure of the first transformed logic circuit is redundant; and
responsive to determining that at least one structure of the first transformed logic circuit is redundant, creating, by the one or more processing resources, an updated logic circuit by removing the at least one structure of the first transformed logic circuit.

7. The method of claim 6, wherein creating the first transformed logic circuit further includes determining, at random, the target logic gate of the logic circuit.

8. The method of claim 7, further comprising, prior to creating the first transformed logic circuit:
assigning, by the one or more processing resources to each of a plurality of logic gates of the logic circuit, respective numerical identification; and
determining, by the one or more processing resources based on the numerical identification of the plurality of logic gates, a sequence of a plurality of target logic gates of the logic gates,
wherein determining, at random, the target logic gate of the logic circuit is based on the sequence of a plurality of target logic gates of the logic gates.

9. The method of claim 6, further comprising, responsive to determining that no structure of the first transformed logic circuit is redundant, determining, by the one or more processing resources, a second transformed logic circuit by:
decoupling, by the one or more processing resources, the output of the target logic gate of the logic circuit from the input of the inserted logic gate; and
coupling, by the one or more processing resources, an output of a target logic gate of the first transformed logic circuit to the input of the inserted logic gate, the target logic gate of the first transformed logic circuit being different than the target logic gate of the logic circuit.

10. The method of claim 9, wherein:
creating the first transformed logic circuit further includes determining, at random, the target logic gate of the logic circuit; and
creating the second transformed logic circuit further includes determining, at random, the target logic gate of the logic circuit.

11. The method of claim 9, further comprising
determining, by the one or more processing resources, whether at least one structure of the second transformed logic circuit is redundant; and
responsive to determining that at least one structure of the second transformed logic circuit is redundant, determining, by the one or more processing resources, a different updated logic circuit by removing the at least one structure of the second transformed logic circuit.

12. The method of claim 11, further comprising, responsive to determining that no structure of the second transformed logic circuit is redundant, determining, by the one or more processing resources, a third transformed logic circuit by:
decoupling the output of the target logic gate of the second transformed logic circuit from the input of the inserted logic gate; and
coupling an output of a target logic gate of the second transformed logic circuit to the input of the inserted logic gate, the target logic gate of the second transformed logic circuit being different than the target logic gate of the first transformed logic circuit.

13. The method of claim 6, further comprising, subsequent to creating the updated logic circuit, determining, by the one or more processing resources based on the updated logic circuit, whether to perform an optimization on the updated logic circuit.

14. The method of claim 13, further comprising determining, by the one or more processing resources based on the updated logic circuit, a type of the optimization to perform on the updated logic circuit.

15. A computer-implemented method for error correction of a logic circuit, comprising:
inserting, by one or more processing resources, one or more circuit elements associated with a first AND operation into the logic circuit, wherein inputs of the first AND operation include a first implied signal of the logic circuit corresponding to a target function of the logic circuit and a second implied signal of the logic circuit corresponding to the target function, wherein the first implied signal is different from the second implied signal; and
determining, by the one or more processing resources, whether an output signal of the first AND operation matches the target function.

16. The method of claim 15, further comprising, responsive to determining that the output signal of the first AND operation does not match the target function of the logic circuit:
marking as controlled, by the one or more processing resources, one or more first bit locations of the target function corresponding to one or more bit locations of the output signal of the first AND operation having a value of logic zero;
inserting, by the one or more processing resources, one or more circuit elements associated with a first OR operation into the logic circuit, wherein input signals of the first OR operation:
are based on a first implying signal of the logic circuit corresponding to the target function and a second implying signal of the logic circuit corresponding to the target function, wherein the first implying signal is different from the second implying signal, and
disregard values associated with the one or more first bit locations of the target function marked as controlled; and
determining, by the one or more processing resources, whether an output signal of the first OR operation matches the target function.

17. The method of claim 16, further comprising, responsive to determining that the output signal of the first OR operation does not match the target function:
inserting, by the one or more processing resources, one or more circuit elements associated with a second AND operation into the logic circuit, wherein inputs of the second AND operation include the output signal of the first AND operation and the output signal of the first OR operation; and
determining, by the one or more processing resources, whether an output signal of the second AND operation matches the target function of the logic circuit.

18. The method of claim 17, further comprising, responsive to determining that the output signal of the second AND operation does not match the target function of the logic circuit:
marking as controlled, by the one or more processing resources, one or more second bit locations of the target function corresponding to one or more bit locations of the output signal of the second AND operation having a value of logic one;
inserting, by the one or more processing resources, one or more circuit elements associated with a third AND operation into the logic circuit, wherein inputs of the third AND operation:
are based on the output signal of the first AND operation and a third implied signal of the logic circuit corresponding to the target function, wherein the third implied signal is different from the second implied signal, and
disregard values associated with the one or more second bit locations of the target function marked as controlled; and
determining, by the one or more processing resources, whether an output signal of the third AND operation matches the target function of the logic circuit.

19. The method of claim 18, further comprising, responsive to determining that the output signal of the third AND operation does not match the target function:
marking as controlled, by the one or more processing resources, one or more third bit locations of the target function corresponding to one or more bit locations of the output signal of the third AND operation having a value of logic zero;
inserting, by the one or more processing resources, one or more circuit elements associated with a second OR operation into the logic circuit, wherein inputs of the second OR operation:
are based on a third implying signal of the logic circuit corresponding to the target function, wherein the third implying signal is different from the second implying signal, and
disregard values associated with the one or more third bit locations of the target function marked as controlled; and
determining, by the one or more processing resources, whether an output signal of the second OR operation matches the target function.

20. The method of claim 19, further comprising, responsive to determining that the output signal of the second OR operation does not match the target function:
inserting, by the one or more processing resources, one or more circuit elements associated with a fourth AND operation into the logic circuit, wherein inputs of the fourth AND operation include the output signal of the third AND operation and the output signal of the second OR operation; and
determining, by the one or more processing resources, whether an output signal of the fourth AND operation matches the target function of the logic circuit.
